(19) United States
(12) Patent Application Publication
(10) Pub. No.: US 2007/0259676 A1
(43) Pub. Date: Nov. 8, 2007

(54) METHOD AND SYSTEM FOR BRIDGING COMMUNICATIONS BETWEEN MOBILE DEVICES AND APPLICATION MODULES

(76) Inventor: Vidyasagar Golla, San Jose, CA (US)

Correspondence Address: HAHN AND MOODLEY, LLP, P.O. BOX 52050, MINNEAPOLIS, MN, 55402, US

(21) Appl. No.: 11/741,260

(22) Filed: Apr. 27, 2007

Related U.S. Application Data
(60) Provisional application No. 60/797,878, filed on May 5, 2006.
(60) Provisional application No. 60/888,300, filed on Feb. 5, 2007.

(51) Int. Cl. H04Q 7/20

(52) U.S. Cl. 455/463

(57) ABSTRACT

In one embodiment, the invention provides a method, comprising: associating a proxy server with a web application; generating a list comprising a selection of parts of the web application to expose to a mobile device; and using the proxy to selectively expose parts of the web application to the mobile device based on the list.

This application claims the benefit of priority to United States Provisional Patent Application Number US 60/797,878 and to United States Provisional Patent Application Number US 60/888,000 both of which are incorporated herein by reference.

### FIELD OF THE INVENTION

Embodiments of the invention relate to techniques for bridging communications between mobile devices and networked devices. Embodiments of the invention also relate to a gateway device for bridging communications between mobile devices and networked devices.

### BACKGROUND

Mobile devices such as mobile phones, pocket personal computers (PCs), personal digital assistants (PDAs), smart phones, etc. have become ubiquitous. In many cases, these mobile devices are enabled to communicate with applications and devices over a wide area network (WAN) such as, the Internet. In fact it has become quite common for these mobile devices to be equipped with mobile web browsers so facilitate interaction with web applications. As one skilled in the art will appreciate, the mobile devices are quite different from desktop and laptop systems in terms of processing power, screen size and resolution, and memory capacity. Additionally these mobile devices communicate via a wireless networks that generally have greater limitations on data transfer speeds and bandwidth than wired networks. For at least these differences web applications written to interact with desktop and laptop systems generally do not interact well with mobile devices. For example, a web page from a web application may include images that may take a long time to download to a mobile device given the data transfer limitations of the wireless network used by the mobile device, whereas the same images may be downloaded and viewed on a desktop or laptop system without such latency.

To address the issues concerning how web applications interact with mobile devices, application providers have generally followed the approach of providing two distinct web applications viz. one designed to interact with desktop and laptop systems and another designed to interact with mobile devices. For example, a web application designed to interact with a mobile devices may have limited functionality when compared to the equivalent web application designed to interact with a desktop or laptop system. Additionally, the web application designed for the mobile device may have images removed so that web pages may be downloaded and rendered faster.

One disadvantage of having to develop and maintain two different versions of a web application as described above is higher costs. As a result some application providers do not provide versions of their web applications designed to interact with mobile devices.

Another problem is that to develop web application for mobile devices, in many cases proprietary or vendor-specific technology has to be used. For example proprietary Application Program Interfaces (APIs) such as the Java 2 Platform Micro Edition (J2ME) or Openwave's Software Development Kit (SDK).

### SUMMARY OF THE INVENTION

According to a one aspect of the invention, there is provided a method for bridging communications between a mobile device and a networked device over a network, the method comprising: receiving a request identifying a network address for the networked device; determining if the request is from the mobile device; obtaining interface code from the networked device, the interface code representing an interface to an application; if the request is from the mobile device then analyzing the interface code to determine functions that the application supports; determining which of the determined functions to expose to the mobile device; forming a modified interface code including removing those functions that are not to be exposed to the mobile device from the interface code; and sending the modified interface code to the mobile device.

According to a second aspect of the invention, there is provided a gateway device, comprising: an interface to receive a request from a mobile device, the request being to a network address of a networked device; a request analyzer to determine if the request is from the mobile device, a request service module to obtain interface code from the networked device for an application running on the networked device; and a profiling engine to determine, in the case of the request being from the mobile device, what functions the application supports, and to form modified interface code with those functions that are not to be exposed to the mobile device removed from the interface codes wherein the request service module sends the modified interface code to the mobile device.

The gateway device may comprise an administrative module to allow an administrator to select those functions from the determined functions that are to be exposed to the mobile device.

The method may comprise simply sending the interface code received from the networked device to the mobile device in the case of the request being from a desktop or laptop system.

The interface code may be browser code in a markup language. The term “browser code” refers to code that can be interpreted by a browser. The markup language may be the Hyper Text Markup Language (HTML) or a derivative thereof.

Analyzing the interface code to the determine functions that the application supports may comprise parsing the browser code for action-value pairs and for links to server scripts. Determining if the request is from that mobile device may be based on information on a type of browser for the mobile device, which information is embedded in the request.

Forming the modified interface code may comprise removing presentation elements from the browser code. The presentation elements may comprise image data, animation elements, or frames defined e.g. using HTML

Other aspects of the invention will be apparent from the detailed description below.

### BRIEF DESCRIPTION OF THE DRAWINGS

FIG. 1 shows a high-level block diagram of a communications system in accordance with one embodiment of the invention;

FIG. 2 shows a highlevel block diagram of gateway device in accordance with one embodiment of the invention;

FIGS. 3 and 4 show flowcharts of operations performed by gateway device of FIG. 2, in accordance with one embodiment of the invention;

FIG. 5 shows a high-level block diagram of hardware that may be used to implement the gateway device of FIG. 2, in accordance with one embodiment of the invention; and

FIG. 6 shows a flowchart for web application learning, in accordance with one embodiment of the invention

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the present invention disclose techniques to transform or modify code so that the code can be rendered on a mobile device constrained by low processing power, screen size and resolution, memory capacity, and data transfer speeds, As used herein the term “mobile device” is to be construed broadly to include mobile phones, pocket personal computers (PCs), personal digital assistants (PDAs), smart phones, etc. as well as devices with a small screen size e.g. display devices mounted on refrigerators. In one embodiment, the code may be browser code for a web application, however this is intended to be non-limiting. Thus, for example, in one embodiment the code may include HTTP. In another embodiment that code may include SOAP syntax to support web services. The transformation or modification of the code is performed by a gateway device that includes a profiling engine for this purpose. In one embodiment, the gateway device is deployed between the mobile device and a networked device (e.g. a server device) that runs an application (hereinafter the “target application”) (e.g. a web application) that the mobile device wishes to interact with.

In one embodiment the transformation of the code is to present a subset of the functions provided by the target application so that only the subset of functions is exposed to the mobile device. In the context of the trend towards “fat web applications that provide a plethora of functions using the AJAX and/or the Web 2.0 standards, in one embodiment the subset of functions may be selected based on the above-described limitations of the mobile device. In another embodiment, the subset of functions may be selected based upon behavioral patterns of mobile device users. For example, it may be determined in the case of a web stock trading application that mobile users are likely to only use a function to check a stock's price, or a function to place a trade, in this case only these functions may be exposed to the mobile device via the subset of functions. Other functions provided by the web stock trading application, such as a function to research a stock, a function to chart a stock, etc. may not be exposed to the mobile device. Advantageously, the techniques described herein do not require two versions of a web application, as described in the background section. Further, by using the techniques disclosed herein, it is not necessary to use proprietary platforms or toots to provide functions for mobile devices. Other advantage will be apparent from the description below.

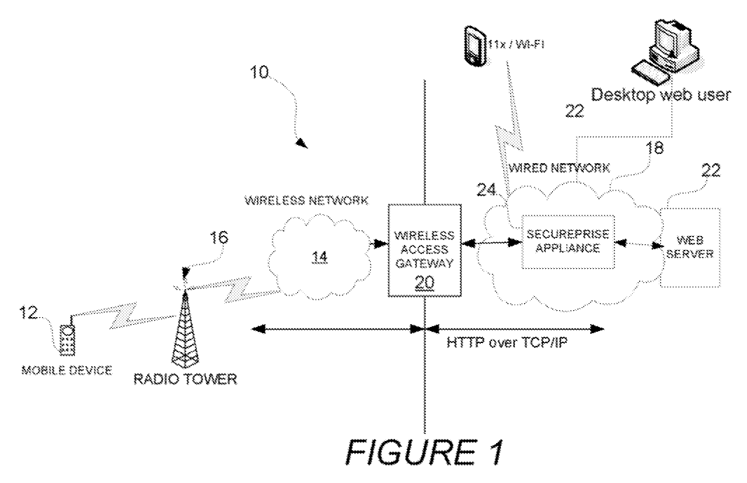

FIG. 1 shows a schematic drawing of a network environment 10 in which embodiments of the techniques described herein may be practiced. As shown in FIG. 1, a mobile device 12, such as for example a mobile telephone communicates with a wireless network 14 via a radio tower 16. The wireless network 14 may, for example, be a network such as a Mobile Digital Packet Data (MDPD) network, a Global System for Mobile (GSM) network, a Code Division Multiple Access (CDMA) network, or a Time Division Multiple Access (TDMA) network. The communications protocol used by the wireless network 14 includes the Wireless Application Protocol (WAP), for example.

The wireless network 14 connects to a wired network 18, such as for example the Internet, via a Wireless Access gateway 20. The Wireless Access gateway 20 serves to convert communications as they pass between the wireless network 14 and the wired network 18. A networked device in the form of a web server 22 is coupled to the wired network 18 in conventional fashion, As will be seen a gateway device 24 is interposed between the mobile device 12 and the web server 22 and bridges communications between the two devices, as will be described.

The functions and operations of the blocks described in FIG. 1 may be implemented in a number of devices, circuits, or infrastructure. Further, a number of the functional blocks may be integrated in a single device and the functions described as performed in any single device may be implemented over several devices. For example, the web server 22 may actually include a number of server devices that together provide functions for a web application.

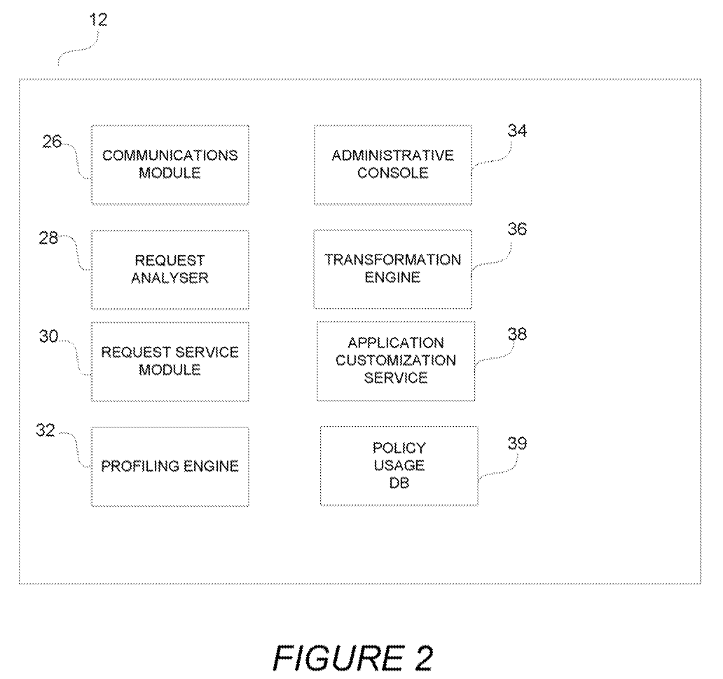

FIG. 2 of the drawings shows a high-level functional block diagram of the gateway device 24, in accordance with one embodiment of the invention. As will be seen, the gateway device 24 includes a communications module 26 to facilitate communications with other devices e.g. communications with the mobile device 12 and communications with the web server 22. The gateway device 24 also includes a request analyzer 28 which implements logic to determine whether a request is from a mobile device as opposed to from a desktop or laptop system. A request service module 30 includes logic to service a request to the web server 22 from a mobile device or from a desktop/laptop system, as will be described. A profiling engine 32 profiles interface for an application running on the web server 22, as will be described. For administrative control the gateway device 24 includes an administrative console 34 that provides functions to an administrator, as will be described. A transformation engine 36 applies transformations to the interface code received from the web server 22, as will be described.

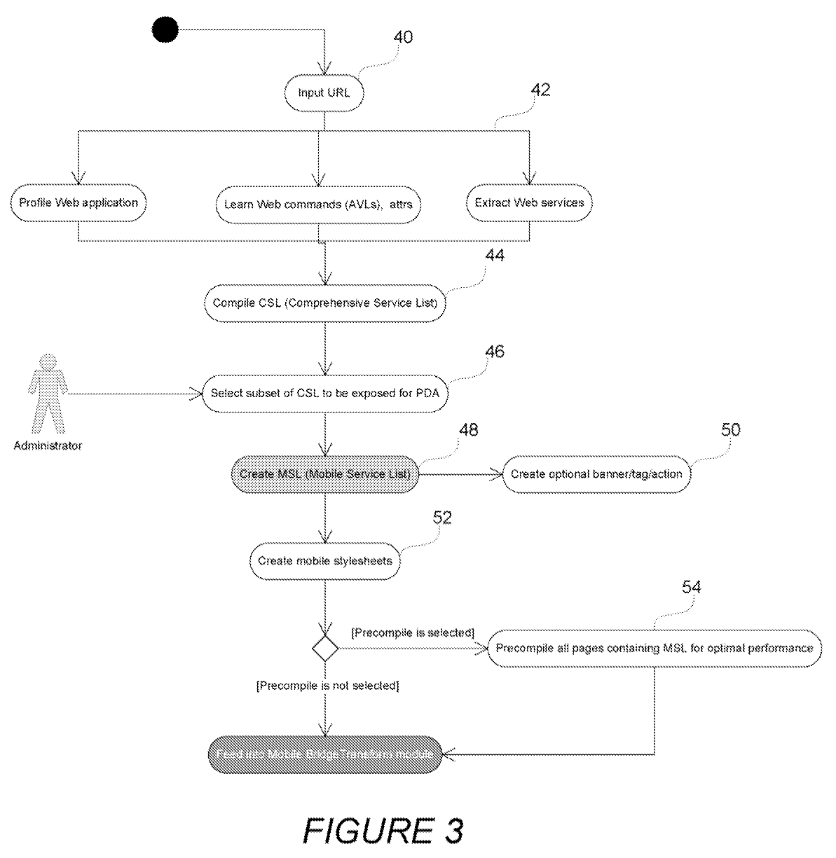

Turning now to FIG. 3 of the drawings, there is a shown a flowchart for a setup or configuration method performed by the gateway device 24, in accordance with one embodiment. As will be seen, at block 40 a request is received from a device. The request includes an input uniform resource locator (URL) that may be from the mobile device 12 or from a desktop/laptop device. The operations at block 40 include an operation to determine whether the request is from the mobile device 12 or from a desktop/laptop system. This operation is performed by the request analyzer 28. In one embodiment the determination of whether the request is from the mobile device 12 or from the desktop/laptop system is based on a information identifying the browser that was used to make the request.

In response to receiving the request, the request service module 30 sends the request to the network address corresponding to the URL. For purposes of discussion it is assumed that the network address is that of the web server 22. Thus, the request service module 30 sends that request to the web server 22. In response to the request, the request service module 30 receives interface code from the web server 22. The interface code represents an interface to a target application running on the web server 22. For example, the target application may by a web mail application such as Yahoo mail. The interface code may than comprise the HTML code for the page at the URL identified in the request.

Continuing with FIG. 3 of the drawings, at block 42 the profiling engine 32 analyses or profiles the interface code to determine the functions that the target application supports. In one embodiment, the profiling step is only performed in the case of the request being from the mobile device 22. Profiling the interface code includes learning the web commands that the target application supports as well as extracting the services associated with the target application. In one embodiment, profiling involves selecting parts of the target application that are appropriate for mobile use. As will be described later, in one embodiment, a software tool learns which components of the target application are appropriate for mobile use based on the login forms, commands, and tables seen during a user's interaction with the target application using a desktop system. Thus, the target application may be personalized based on the users' usage using a desktop system. In one embodiment, this personalization is performed even where communications between a mobile device and a target application are in accordance with a cryptographic protocol such as the SSL (Secure Sockets Layer) protocol.

In one embodiments the profiling may be achieved by parsing the interface code to determine server scripts therein. By way of example, server scripts may be determined by action-value pairs associated with form tags of HTML script. Server scripts may also be determined through analysis of link tags. Once the profiting at block 42 is completed, the functions provided by the target application are known.

At block 44, a comprehensive service list (CSL) is compiled for the functions that the target application provides. The CSL is provided to an administrator of the gateway device 24, who then selects a subset of the CSL to be exposed to the mobile device 12. This step is indicated by reference numeral 46 in FIG. 3. Based on the selection of the functions from the CSL, a My Service List (MSL) is created at block 48. The MSL contains only those functions or services that were selected to be exposed to the mobile device 12. At block 50, which is optional, banners/tags/actions may be created to control presentation of data on the mobile device. At block 52, mobile style sheets are created for the interface code to control how the interface code is rendered by a browser of the mobile device 12. Thus, in one embodiment, web pages may be re-formatted based on limitations of a mobile device.

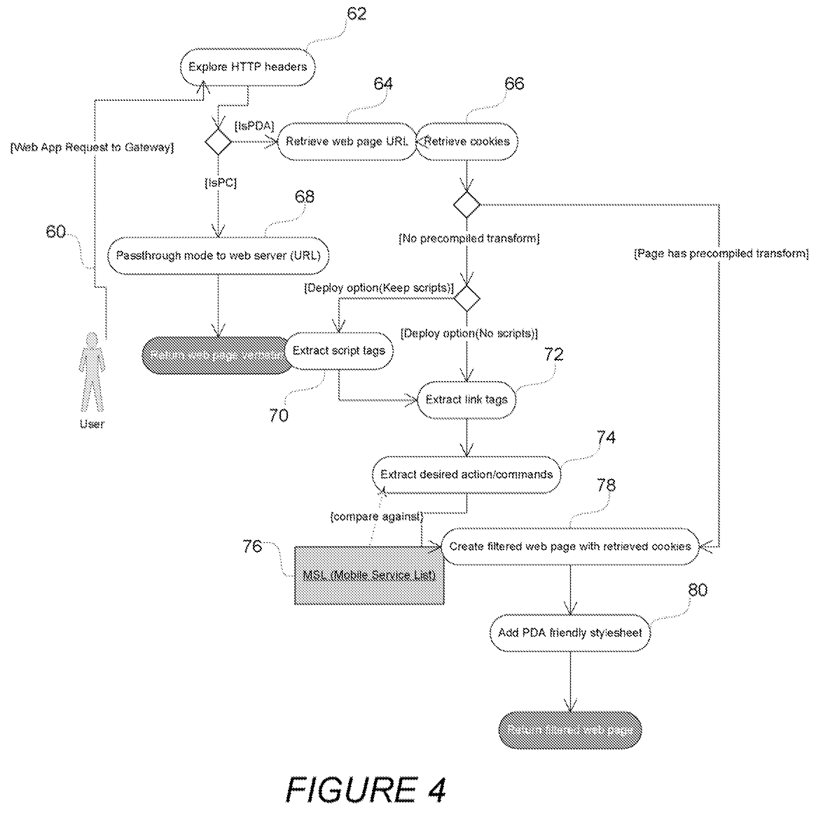

Turning now to FIG. 4 of the drawings, there is shown a flowchart of operations performed by the gateway device 24 in order to transform content for a mobile device, in accordance with one embodiment of the invention. As will be seen at 60, the gateway device 24 receives a request. At 62, the request analyzer 28 analyzes the headers associated with the request to determine the source of the request. If the request is from a mobile device (e.g. a PDA) then control passes to block 64, otherwise control passes to block 66. The operations performed at block 66 implement a “pass through” mode wherein the request is sent to the web server 22 and interface code(e.g. for a web page) associated with the target application is returned to the desktop/laptop system that made that request verbatim i.e. without any transformations.

At block 64, the interface code associated with the request is retrieved from the web server 22. At block 68: any cookies associated with the interface code are retrieved from the web server 22. In one embodiment, the administrator via the mechanism of the administrative console 34 may set the gateway device 22 to block client-side scripts in the interface code. If client-side script blocking or suppression is set then at block 70 the transformation engine 36 extracts or removes the script tags from the interface code. At block 74, link tags in the interface codes are extracted. At block 74 actions and commands in the interface code are extracted. At block 76, the function or services enabled in the interface code as determined by the extractions of blocks 72, and 74 are compared against the services/functions that are set to be exposed to the mobile device 12 in the MSL. At block 78, the transformation engine 36 generates a modified interface code containing only the functions/services from the MSL. At block 80, a style sheet generated for the mobile device 12 is selected and the modified interface code and the selected style sheet are returned to the mobile device. In cases where a mobile device cannot process cookies set by the web server 22, on transformation to the interface code may by the removal of the cookies from the interface code and the corresponding replacement of the removed cookies with hidden parameters, which are then used by the gateway device 24 to manage a session between the mobile device 22 and the server 24.

In the foregoing, the invention has been described in the context of providing mobile-friendly or optimized content to mobile devices. However, it is to be understood that techniques and systems disclosed herein may be applicable to cases where filtering may be applied based on user-specific criteria instead of device-specific criteria. For example, an administrator may set the gateway device 22 to filter content based on the user that initiates a request. Thus, for example, services/functions to an Oracle database for example may be selectively exposed to a user based on the user's login information.

In one embodiment, if the target application requires user-information such as login credentials personal information such as height gender location or preference e.g. wine preference, the gateway device 24 through the profiling engine 32 “learns” i.e. saves the user information the first time it is entered. Thereafter, the gateway device 24 provides the user information to the target application without the user having to enter it again.

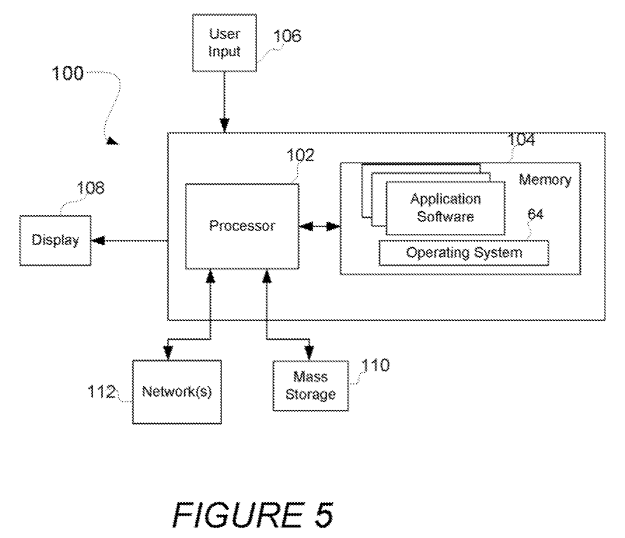

FIG. 5 of the drawings shows an example of hardware 100 that may be used to implement the gateway device 24 in accordance with one embodiment of the invention. The hardware 100 typically includes at least one processor 102 coupled to a memory 104. The processor 102 may represent one or more processors (e.g., microprocessors), and the memory 104 may represent random access memory (RAM) devices comprising a main storage of the hardware 100, as well as any supplemental levels of memory e.g., cache memories, non-volatile or back-up memories (e.g. programmable or flash memories), read-only memories, etc. In addition, the memory 104 may be considered to include memory storage physically located elsewhere in the hardware 100, e.g. any cache memory in the processor 102 as well as any storage capacity used as a virtual memory, e.g. as stored on a mass storage device 110.

The hardware 100 also typically receives a number of inputs and outputs for communicating information externally. For interface with a user or operator, the hardware 100 may include one or more user input devices 106 (e.g. a keyboard, a mouse etc.) and a display 108 (e.g. a Liquid Crystal Display (LCD) panel). For additional storage, the hardware 100 may also include one or more mass storage devices 110>e.g. a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 100 may include an interface with one or more networks 112 (e.g., a local area network (LAN)>a wide area network (WAN), a wireless network, and/or the Internet among others) to permit the communication of information with other computers coupled to the networks. It should be appreciated that the hardware 100 typically includes suitable analog and/or digital interfaces between the processor 102 and each of the components 104, 106, 108 and 112 as is well known In the art.

The hardware 100 operates under the control of an operating system 104>and executes various computer software applications, components, programs, objects, modules, etc. to perform the filtering techniques described above. Moreover, various applications, components, programs, objects, etc. may also execute on one or more processors in another computer coupled to the hardware 100 via a network 112, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

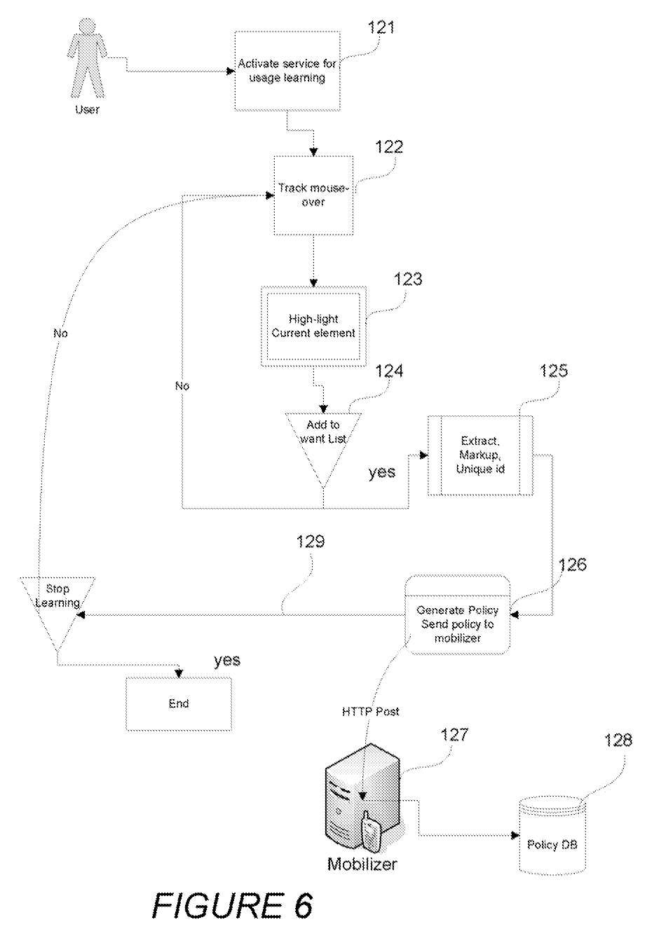

In one embodiment a software tool may be provided to facilitate the creation of the MSL. In one embodiment, the software tool may be in the form of a browser plug-in or extension. In another embodiment, the software tool may be in the form of non-downloadable software provided over the Internet. The browser plug-may be installed on a desktop computer 25 which is coupled to the wired network (see FIG. 1). Broadly, when a user views or interacts with a web page, the plug-in determines which objects that make up the web page to include in the MSL. In one embodiment, the plug-in determines the objects based on user input. For example, FIG. 6 of the drawings shows exemplary operations performed by the browser plug-in, in accordance with one embodiment of the invention, to add objects from a web page or a preference parameter for any web application to the MSL. Referring to FIG. 6, at block 121 the plug-in is activated. At block 122, the plug-in tracks movement of a pointing device, such as a mouse. At block 123 the plug-in causes the web page object being pointed to by the pointing device to be highlighted. At block 124, the plug-in gives the user the option to select the highlighted object as one for inclusion in the MSL. If the highlighted object is selected for inclusion, then a unique identifier associated with the highlighted object is extracted, and at block 126 a policy is generated to allow the object to be exposed to a mobile device. In other words, the unique identifier is added to the MSL. At block, 127 the policy is saved in a policy database 128. In one embodiment, the policy database 128 may be part of a mobilizer component which may be implemented in the gateway device 24. If the plug-in, receives input to stop at block 129, then the operations of the plug-in end, otherwise control passes to block 122.

In some cases, the software tool may determine or “learn” what parts of a web application to expose to a mobile device in a dynamic way based on a user's interaction with the web application. In such cases the software tool monitors the user's interaction with the web application and selects the components of the web application to be exposed to the mobile device based on a frequency with which the components are accessed.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

1. A method, comprising:
associating a proxy server with a web application;
generating a list comprising a selection of parts of the web application to expose to a mobile device; and
using the proxy to selectively expose parts of the web application to the mobile device based on the list.

2. The method of claim 1, wherein generating the list comprises analyzing the web application to determine its parts and allowing a user to make the selection via an interface.

3. The method of claim 2, wherein the interface comprises a graphical interface.

4. The method of claim 1, wherein the parts of the web application comprises services and commands to allow dynamic interaction with the web application.

5. The method of claim 1, wherein selectively exposing parts of the web application comprises reformatting web pages for viewing on the mobile device, based on limitations of the mobile device.

6. The method of claim 1, wherein selectively exposing parts of the web application is performed while maintaining state information of a session between the mobile device and the web application.

7. A system comprising:
a processor; and
a memory coupled to the processor, the memory storing instructions which when executed by the processor caused the system to perform a method comprising:
associating a proxy server with a web application;
generating a list comprising a selection of parts of the web application to expose to a mobile device; and
using the proxy to electively expose parts of the web application to the mobile device based on the list.

8. The system of claim 7, wherein generating the list comprises analyzing the web application to determine its parts; and allowing a user to make the selection via an interface.

9. The system of claim 8, wherein the interface comprises a graphical interface.

10. The system of claim 7, wherein the parts of the web application comprises services and commands to allow dynamic interaction with the web application.

11. The system of claim 7, wherein selectively exposing parts of the web application comprises reformatting web pages for viewing on the mobile device, based on limitations of the mobile device.

12. The system of claim 7, wherein selectively exposing parts of the web application is performed while maintaining state information of a session between the mobile device and the web application

13. A computer-readable medium comprising a sequence of instructions which when executed by a processor, cause the processor to perform a method, comprising:
associating a proxy server with a web application;
generating as list comprising a selection of parts of the web application to expose to a mobile device; and
using the proxy to selectively expose parts of the web application to the mobile device based on the list.

14. The computer-readable medium of claim 13, wherein generating the list comprises analyzing the web application to determine its parts; and allowing a user to make the selection via an interface.

15. The computer-readable medium of claim 14, wherein the interface comprises a graphical interface.

16. The computer-readable medium of claim 13, wherein the parts of the web application comprises services and commands to allow dynamic interaction with the web application.

17. The computer-readable medium of claim 13, wherein selectively exposing parts of the web application comprises reformatting web pages for viewing on the mobile device, based on limitations of the mobile device.

18. The computer-readable medium of claim 13, wherein selectively exposing parts of the web application is performed while maintaining state information of a session between the mobile device and the web application.
